(19) United States
(12) Patent Application Publication
(10) Pub. No.: US 2021/0256729 A1
(43) Pub. Date: Aug. 19, 2021

(54) METHODS AND SYSTEMS FOR DETERMINING CALIBRATION QUALITY METRICS FOR A MULTICAMERA IMAGING SYSTEM

(71) Applicant: Proprio, Inc., Seattle, WA (US)

(72) Inventors: David Julio Colmenares, Seattle, WA (US); Thomas Ivan Nonn, Kenmore, WA (US); James Andrew Youngquist, Seattle, WA (US)

(21) Appl. No.: 17/173,973

(22) Filed: Feb. 11, 2021

Related U.S. Application Data
(60) Provisional application No. 62/976,248, filed on Feb. 13, 2020.

(51) Int. Cl. G06T 7/73; G06T 7/55; G06T 7/33

(52) U.S. Cl. CPC G06T 7/73; G06T 7/33; G06T 7/55

(57) ABSTRACT

Methods of validating cameras in a computational imaging system, and associated systems are disclosed herein. In some embodiments, a method can include quantifying calibration error by directly comparing computed images and raw camera images from the same camera pose. For example, the method can include capturing raw images of a scene and then selecting one or more cameras for validation. The method can further include generating, for each of the cameras selected for validation, a virtual image of the scene corresponding to the pose of the camera. Then, the raw image captured with each of the cameras selected for validation is compared with the virtual image to calibrate and/or classify error in the imaging system.

### CROSS-REFERENCE TO RELATED APPLICATION

This application claims the benefit of and priority to U.S. Provisional Patent Application No. 62/976,248, filed Feb. 13, 2020, titled “METHODS AND SYSTEMS FOR DETERMINING CALIBRATION QUALITY METRICS FOR A MULTICAMERA IMAGING SYSTEM,” which is incorporated herein by reference in its entirety.

### TECHNICAL FIELD

The present technology generally relates to computational imaging systems including multiple cameras and, more specifically, to methods and systems for determining calibration quality metrics for multicamera imaging systems.

### BACKGROUND

Multicamera imaging systems are becoming increasingly used to digitize our understanding of the world, such as for measurement, tracking, and/or three-dimensional (3D) reconstruction of a scene. These camera systems must be carefully calibrated using precision targets to achieve high accuracy and repeatability. Typically, such targets consist of an array of feature points with known locations in the scene the that can be precisely identified and consistently enumerated across different camera frames and views. Measuring these known 3D world points and their corresponding two-dimensional (2D) projections in images captured by the cameras allows for intrinsic parameters (e.g., focal length) and extrinsic parameters (e.g., position and orientation in 3D world space) of the cameras to be computed.

The calibration of multicamera imaging systems will typically degrade over time due to environmental factors. The gradual degradation of system performance is often hard to detect during normal operation. As a result, it is typically left to the discretion of the user to periodically check the calibration quality of the system using the calibration target and/or to simply recalibrate the system.

Known calibration techniques can generally be classified into two categories: (i) calibration based on known targets in the scene and (ii) calibration based on correlating feature points across different cameras views. When calibrating based on known targets in the scene, the target provides known feature points with 3D world positions. The corresponding 2D projected points in the camera images are compared to the calculated 2D locations based on the calibration. A reprojection error is calculated as the difference between these measurements in pixels. Therefore, the calibration quality can be measured with a calibration target and quantified with reprojection error. However, such techniques require that known targets be positioned and visible within the scene.

When correlating feature points across different cameras views, the correlated features can be, for example, reflective marker centroids from binary images (e.g., in the case of an optical tracking system), or scale-invariant feature transforms (SIFT) from grayscale or color images (e.g., for general camera systems). With these correlated features, the system calibration can be improved using bundle adjustment—an optimization of the calibration parameters to minimize reprojection error. However, unlike calibration with a known target, bundle adjustment typically includes scale ambiguity. Even with gauge fixing constraints applied, due to the complex multivariate nature of bundle adjustment there are many local minima in the correlation. Accordingly, solutions can be determined that minimize reprojection error—but that do not improve system accuracy. That is, agreement between cameras is improved, but the intrinsic and/or extrinsic parameters of the cameras can diverge from their true values such that the measurement accuracy of the system is reduced compared to known target calibration techniques. Furthermore, the process of calculating image features, correctly matching them across camera views, and performing bundle adjustment is computationally expensive and can have errors due to noise intrinsic in the physical process of capturing images. For high-resolution, multicamera imaging systems such as those used for light field capture, the computational complexity increases substantially along with the presence of non-physical local minima solutions to bundle adjustment.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 is a schematic view of an imaging system configured in accordance with embodiments of the present technology.

FIG. 2 is a perspective view of a surgical environment employing the imaging system of FIG. 1 for a surgical application in accordance with embodiments of the present technology.

FIG. 3 is a schematic diagram of a portion of the imaging system illustrating camera selection for comparing a rendered image to a raw image to assess calibration in accordance with embodiments of the present technology.

FIGS. 4A-4C are schematic illustrations of a raw image captured by a selected camera of the imaging system, a virtual image rendered to correspond with the selected camera, and a difference between the raw image and the virtual image, respectively, in the case of accurate system calibration in accordance with embodiments of the present technology.

FIG. 5 is a schematic diagram of the portion of the imaging system shown in FIG. 3 illustrating the effects of calibration error and depth error in accordance with embodiments of the present technology.

FIGS. 6A-6C are schematic illustrations of a raw image captured by a selected camera of the imaging system, a virtual image rendered to correspond with the selected camera, and a difference between the raw image and the virtual image, respectively, in the case of calibration error and depth error in accordance with embodiments of the present technology.

FIGS. 7A-7C are schematic illustrations of a raw image captured by a selected camera of the imaging system, a virtual image rendered to correspond with the selected camera, and a difference between the raw image and the virtual image, respectively, in the case of the selected camera having a relatively large error compared to an average system error in accordance with embodiments of the present technology.

FIG. 8 is a schematic diagram of a portion of the imaging system including cameras of two different types and illustrating camera selection for comparing a rendered image to a raw image to assess calibration of the imaging system in accordance with embodiments of the present technology.

FIGS. 9A-9C are schematic illustrations of a raw image captured by a selected camera of the imaging system, a virtual image rendered to correspond with the selected camera, and a difference between the raw image and the virtual image, respectively, in the case of transform error in accordance with embodiments of the present technology.

FIG. 10 is a flow diagram of a process or method for computing and/or classifying error metrics for the imaging system in accordance with embodiments of the present technology.

### DETAILED DESCRIPTION

Aspects of the present disclosure are directed generally to methods of assessing the calibration quality of a computational imaging system including multiple cameras. In several of the embodiments described below, for example, a method can include quantifying calibration error by directly comparing computed virtual camera images and raw camera images from the same camera pose. More specifically, the method can include capturing raw images of a scene and then selecting one or more of the cameras in the system for validation/verification. The method can further include computing, for each of the cameras selected for validation, a virtual image of the scene corresponding to the pose (e.g., position and orientation) of the camera. Then, the raw image captured with each of the cameras selected for validation is compared with the computed virtual image to calibrate and/or classify error in the imaging system.

When there is no calibration error, sensor noise, or computational error, the computed and raw images will be identical and a chosen image comparison function will compute an error of zero. However, if there are calibration errors, sensor noise, computational errors, or the like, the comparison function will compute a non-zero error. In some embodiments, the computed error can be classified based on the image comparison as being attributable to one or more underlying causes. In one aspect of the present technology, this classification methodology can be especially useful in attributing error to different subsystems (e.g., different camera types) when the computational imaging system includes multiple heterogenous subsystems that generate different kinds of data.

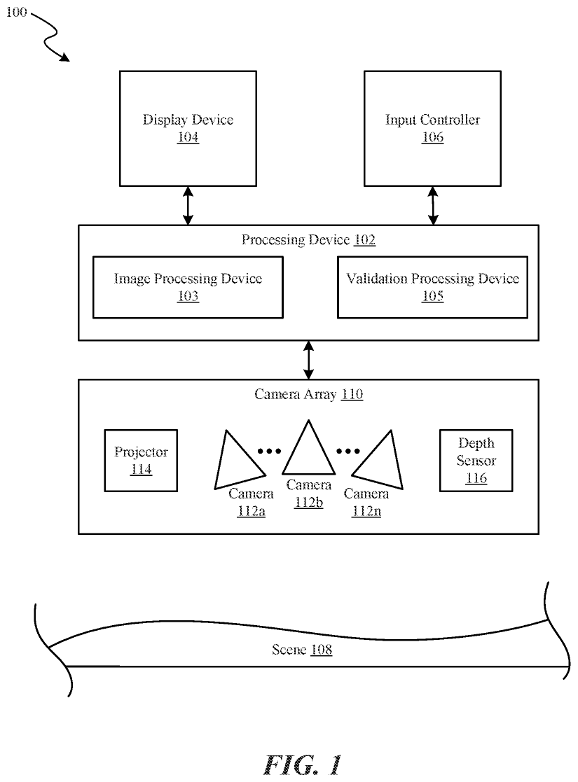

Specific details of several embodiments of the present technology are described herein with reference to FIGS. 1-10. The present technology, however, can be practiced without some of these specific details. In some instances, well-known structures and techniques often associated with camera arrays, light field cameras, image reconstruction, object tracking, and so on, have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying figures depict embodiments of the present technology and are not intended to be limiting of its scope. The sizes of various depicted elements are not necessarily drawn to scale, and these various elements can be arbitrarily enlarged to improve legibility. Component details can be abstracted in the figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

The headings provided herein are for convenience only and should not be construed as limiting the subject matter disclosed.

### I. SELECTED EMBODIMENTS OF IMAGING SYSTEMS

FIG. 1 is a schematic view of an imaging system 100 (“system 100”) configured in accordance with embodiments of the present technology. In some embodiments, the system 100 can be a synthetic augmented reality system, a mediated-reality imaging system, and/or a computational imaging system. In the illustrated embodiment, the system 100 includes a processing device 102 that is operably/communicatively coupled to one or more display devices 104, one or more input controllers 106, and a camera array 110. In other embodiments, the system 100 can comprise additional, fewer, or different components. In some embodiments, the system 100 can include features that are generally similar or identical to those of the imaging systems disclosed in U.S. patent application Ser. No. 16/586,375, titled “CAMERA ARRAY FOR A MEDIATED-REALITY SYSTEM,” file Sep. 27, 2019, which is incorporated herein by reference in its entirety.

In the illustrated embodiment, the camera array 110 includes a plurality of cameras 112 (identified individually as cameras 112a-112n) that are each configured to capture images of a scene 108 from a different perspective. In some embodiments, the cameras 112 are positioned at fixed locations and orientations (e.g., poses) relative to one another. For example, the cameras 112 can be structurally secured by/to a mounting structure (e.g., a frame) at predefined fixed locations and orientations. In some embodiments, the cameras 112 can be positioned such that neighboring cameras share overlapping views of the scene 108. Therefore, all or a subset of the cameras 112 can have different extrinsic parameters, such as position and orientation. In some embodiments, the cameras 112 in the camera array 110 are synchronized to capture images of the scene 108 substantially simultaneously (e.g., within a threshold temporal error). In some embodiments, all or a subset of the cameras 112 can be light-field/plenoptic/RGB cameras that are configured to capture information about the light field emanating from the scene 108 (e.g., information about the intensity of light rays in the scene 108 and also information about a direction the light rays are traveling through space). Therefore, in some embodiments the images captured by the cameras 112 can encode depth information representing a surface geometry of the scene 108.

In some embodiments, the cameras 112 can include multiple cameras of different types. For example, different subsets of the cameras 112 can have different intrinsic parameters such as focal length, sensor type, optical components, and the like. In some embodiments, a subset of the cameras 112 can be configured to track an object through/in the scene 108. The cameras 112 can have charge-coupled device (CCD) and/or complementary metal-oxide semiconductor (CMOS) image sensors and associated optics. Such optics can include a variety of configurations including lensed or bare individual image sensors in combination with larger macro lenses, micro-lens arrays, prisms, and/or negative lenses.

In the illustrated embodiment, the camera array 110 further comprises (i) one or more projectors 114 configured to project a structured light pattern onto/into the scene 108, and (ii) one or more depth sensors 116 configured to estimate a depth of a surface in the scene 108. In some embodiments, the depth sensor 116 can estimate depth based on the structured light pattern emitted from the projector 114. In other embodiments, the camera array 110 can omit the projector 114 and/or the depth sensor 116.

In the illustrated embodiment, the processing device 102 includes an image processing device 103 (e.g., an image processor, an image processing module, an image processing unit) and a validation processing device 105 (e.g., a validation processor, a validation processing module, a validation processing unit). The image processing device 103 is configured to (i) receive images (e.g., light-field images, light field image data) captured by the camera array 110 and (ii) process the images to synthesize an output image corresponding to a selected virtual camera perspective. In the illustrated embodiment, the output image corresponds to an approximation of an image of the scene 108 that would be captured by a camera placed at an arbitrary position and orientation corresponding to the virtual camera perspective. In some embodiments, the image processing device 103 is further configured to receive depth information from the depth sensor 116 and/or calibration data from the validation processing device 105 (and/or another component of the system 100) and to synthesize the output image based on the images, the depth information, and the calibration data. More specifically, the depth information and calibration data can be used/combined with the images from the cameras 112 to synthesize the output image as a 3D (or stereoscopic 2D) rendering of the scene 108 as viewed from the virtual camera perspective. In some embodiments, the image processing device 103 can synthesize the output image using any of the methods disclosed in U.S. patent application Ser. No. 16/457,780, titled “SYNTHESIZING AN IMAGE FROM A VIRTUAL PERSPECTIVE USING PIXELS FROM A PHYSICAL IMAGER ARRAY WEIGHTED BASED ON DEPTH ERROR SENSITIVITY,” filed Jun. 28, 2019, now U.S. Pat. No. 10,650,573, which is incorporated herein by reference in its entirety.

The image processing device 103 can synthesize the output image from images captured by a subset (e.g., two or more) of the cameras 112 in the camera array 110, and does not necessarily utilize images from all of the cameras 112. For example, for a given virtual camera perspective, the processing device 102 can select a stereoscopic pair of images from two of the cameras 112 that are positioned and oriented to most closely match the virtual camera perspective. In some embodiments, the image processing device 103 (and/or the depth sensor 116) is configured to estimate a depth for each surface point of the scene 108 relative to a common origin and to generate a point cloud and/or 3D mesh that represents the surface geometry of the scene 108. For example, in some embodiments the depth sensor 116 can detect the structured light projected onto the scene 108 by the projector 114 to estimate depth information of the scene 108. Alternatively or additionally, the image processing device 103 can perform the depth estimation based on depth information received from the depth sensor 116. In some embodiments, the image processing device 103 can estimate depth from multiview image data from the cameras 112 using techniques such as light field correspondence, stereo block matching, photometric symmetry, correspondence, defocus, block matching, texture-assisted block matching, structured light, and the like., with or without utilizing information collected by the projector 114 or the depth sensor 116. In other embodiments, depth may be acquired by a specialized set of the cameras 112 performing the aforementioned methods in another wavelength, or by tracking objects of known geometry through triangulation or perspective-n-point algorithms. In yet other embodiments, the image processing device 103 can receive the depth information from dedicated depth detection hardware, such as one or more depth cameras and/or a LiDAR detector, to estimate the surface geometry of the scene 108.

In some embodiments, the processing device 102 (e.g., the validation processing device 105) performs a calibration process to detect the positions and orientation of each of the cameras 112 in 3D space with respect to a shared origin and/or an amount of overlap in their respective fields of view. For example, in some embodiments the processing device 102 can calibrate/initiate the system 100 by (i) processing captured images from each of the cameras 112 including a fiducial marker placed in the scene 108 and (ii) performing an optimization over the camera parameters and distortion coefficients to minimize reprojection error for key points (e.g., points corresponding to the fiducial markers). In some embodiments, the processing device 102 can perform a calibration process by correlating feature points across different cameras views and performing a bundle analysis. The correlated features can be, for example, reflective marker centroids from binary images, scale-invariant feature transforms (SIFT) features from grayscale or color images, and so on. In some embodiments, the processing device 102 can extract feature points from a ChArUco target and process the feature points with the OpenCV camera calibration routine. In other embodiments, such a calibration can be performed with a Halcon circle target or other custom target with well-defined feature points with known locations. Where the camera array 110 is heterogenous—including different types of the cameras 112—the target may have features visible only to distinct subsets of the cameras 112, which may be grouped by their function and spectral sensitivity. In such embodiments, the calibration of extrinsic parameters between the different subsets of the cameras 112 can be determined by the known locations of the feature points on the target.

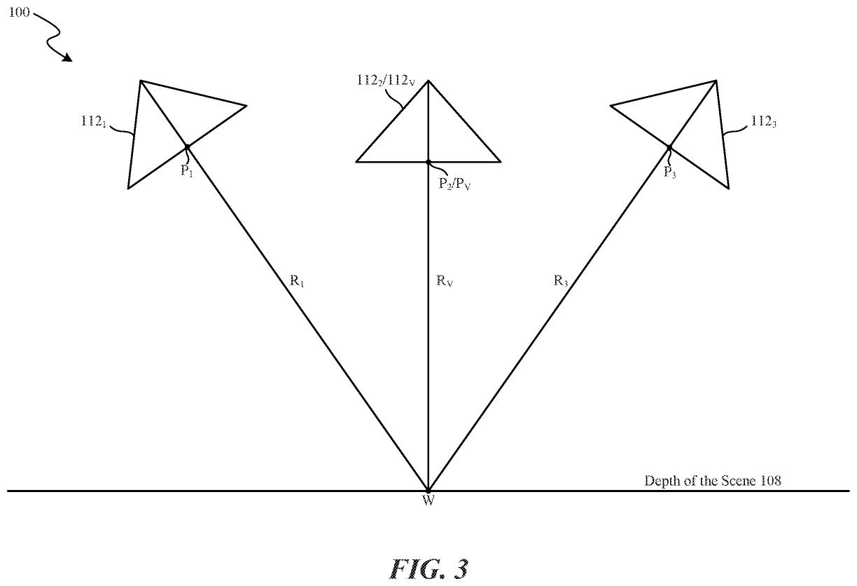

As described in detail below with reference to FIGS. 3-10, the validation processing device 105 is configured to validate/verify/quantify the calibration of the system 100. For example, the validation processing device 105 can calculate calibration metrics before and/or during operation of the system 100 by directly comparing raw images from the cameras 112 with computed images (e.g., corresponding to a virtual camera perspective) from the same camera perspective.

In some embodiments, the processing device 102 (e.g., the image processing device 103) can process images captured by the cameras 112 to perform object tracking of an object within the vicinity of the scene 108. Object tracking can be performed using image processing techniques or may utilize signals from dedicated tracking hardware that may be incorporated into the camera array 110 and/or the object being tracked. In a surgical application, for example, a tracked object may comprise a surgical instrument or a hand or arm of a physician or assistant. In some embodiments, the processing device 102 may recognize the tracked object as being separate from the surgical site of the scene 108 and can apply a visual effect to distinguish the tracked object such as, for example, highlighting the object, labeling the object, or applying a transparency to the object.

In some embodiments, functions attributed to the processing device 102, the image processing device 103, and/or the validation processing device 105 can be practically implemented by two or more physical devices. For example, in some embodiments a synchronization controller (not shown) controls images displayed by the projector 114 and sends synchronization signals to the cameras 112 to ensure synchronization between the cameras 112 and the projector 114 to enable fast, multi-frame, multi-camera structured light scans. Additionally, such a synchronization controller can operate as a parameter server that stores hardware specific configurations such as parameters of the structured light scan, camera settings, and camera calibration data specific to the camera configuration of the camera array 110. The synchronization controller can be implemented in a separate physical device from a display controller that controls the display device 104, or the devices can be integrated together.

The processing device 102 can comprise a processor and a non-transitory computer-readable storage medium that stores instructions that when executed by the processor, carry out the functions attributed to the processing device 102 as described herein. Although not required, aspects and embodiments of the present technology can be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The present technology can be embodied in a special purpose computer or data processor that is specifically programmed, configured or constructed to perform one or more of the computer-executable instructions explained in detail below. Indeed, the term “computer” (and like terms), as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines can be located in both local and remote memory storage devices. Aspects of the invention described below can be stored or distributed on computer-readable media, including magnetic and optically readable and removable computer discs, stored as in chips (e.g., EEPROM or flash memory chips). Alternatively, aspects of the invention can be distributed electronically over the Internet or over other networks (including wireless networks). Those skilled in the relevant art will recognize that portions of the present technology can reside on a server computer, while corresponding portions reside on a client computer. Data structures and transmission of data particular to aspects of the present technology are also encompassed within the scope of the invention.

The virtual camera perspective can be controlled by an input controller 106 that provides a control input corresponding to the location and orientation of the virtual camera perspective. The output images corresponding to the virtual camera perspective are outputted to the display device 104. The display device 104 is configured to receive the output images (e.g., the synthesized three-dimensional rendering of the scene 108) and to display the output images for viewing by one or more viewers. The processing device 102 can beneficially process received inputs from the input controller 106 and process the captured images from the camera array 110 to generate output images corresponding to the virtual perspective in substantially real-time as perceived by a viewer of the display device 104 (e.g., at least as fast as the frame rate of the camera array 110).

The display device 104 can comprise, for example, a head-mounted display device, a monitor, a computer display, and/or another display device. In some embodiments, the input controller 106 and the display device 104 are integrated into a head-mounted display device and the input controller 106 comprises a motion sensor that detects position and orientation of the head-mounted display device. The virtual camera perspective can then be derived to correspond to the position and orientation of the head-mounted display device 104 such that the virtual perspective corresponds to a perspective that would be seen by a viewer wearing the head-mounted display device 104. Thus, in such embodiments the head-mounted display device 104 can provide a real-time rendering of the scene 108 as it would be seen by an observer without the head-mounted display device 104. Alternatively, the input controller 106 can comprise a user-controlled control device (e.g., a mouse, pointing device, handheld controller, gesture recognition controller) that enables a viewer to manually control the virtual perspective displayed by the display device 104.

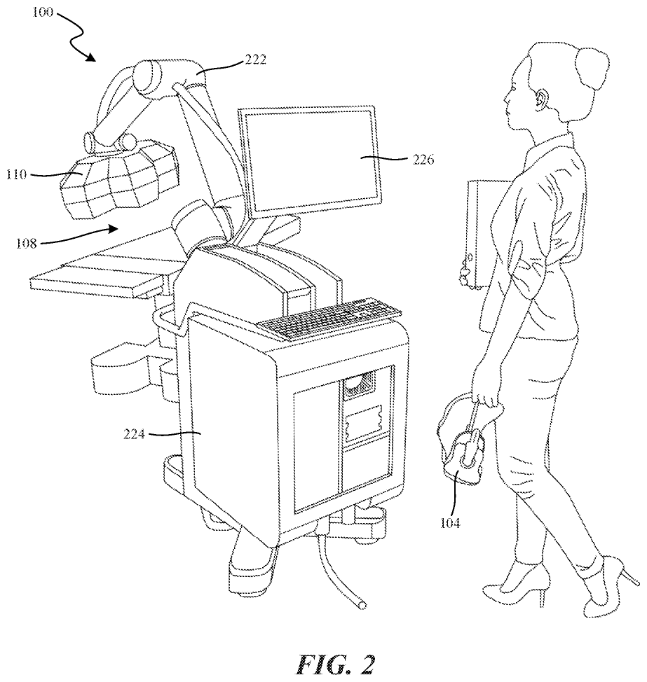

FIG. 2 is a perspective view of a surgical environment employing the system 100 for a surgical application in accordance with embodiments of the present technology. In the illustrated embodiment, the camer339 a array 110 is positioned over the scene 108 (e.g., a surgical site) and supported/positioned via a swing arm 222 that is operably coupled to a workstation 224. In some embodiments, the swing arm 222 can be manually moved to position the camera array 110 while, in other embodiments, the swing arm 222 can be robotically controlled in response to the input controller 106 (FIG. 1) and/or another controller. In the illustrated embodiment, the display device 104 is embodied as a head-mounted display device (e.g., a virtual reality headset, augmented reality headset). The workstation 224 can include a computer to control various functions of the processing device 102, the display device 104, the input controller 106, the camera array 110, and/or other components of the system 100 shown in FIG. 1. Accordingly, in some embodiments the processing device 102 and the input controller 106 are each integrated in the workstation 224. In some embodiments, the workstation 224 includes a secondary display 226 that can display a user interface for performing various configuration functions, a mirrored image of the display on the display device 104, and/or other useful visual images/indications.

### II. SELECTED EMBODIMENTS OF METHODS FOR GENERATING CALIBRATION METRICS

Referring to FIG. 1, for the system 100 to generate an accurate output image of the scene 108 rendered from a virtual camera perspective, precise intrinsic and extrinsic calibrations of the cameras 112 must be known. In some embodiments, the processing device 102 (e.g., the validation processing device 105) is configured to validate/verify the calibration of the system 100 by comparing computed and raw images from chosen camera perspectives. More specifically, for example, the validation processing device 105 can choose a subset (e.g., one or more) of the cameras 112 for validation, and then compute images from the perspective of the subset of the cameras 112 using the remaining cameras 112 in the system 100. For each of the cameras 112 in the subset, the computed and raw images can be compared to calculate a quantitative value/metric that is representative of and/or proportional to the calibration quality of the system 100. The comparison can be a direct comparison of the computed and raw images using a selected image comparison function. When there are no calibration errors, sensor noise, or computational errors, the computed and raw images will be identical, and a chosen image comparison function will compute an error of zero. If there are calibration errors, sensor noise, computational errors, or the like, the comparison function will compute a non-zero error.

In some embodiments, the validation processing device 105 can classify the computed error based on the image comparison as being attributable to one or more underlying causes. In one aspect of the present technology, this classification methodology can be especially useful in attributing error to different ones of the cameras 112 when the camera array 110 includes different types of cameras 112 or subsets of the cameras 112 that generate different kinds of data. Accordingly, when the system 100 is heterogenous, the present technology provides a metric for quantifying full system calibration, or the entire tolerance stack across several integrated technologies, which directly impacts the effectiveness of a user operating the system 100. Additionally, the disclosed methods of calibration assessment can be used to assess the registration accuracy of imaging or volumetric data collected from other modalities—not just the cameras 112—that are integrated into the system 100.

In contrast to the present technology, conventional methods for determining calibration error include, for example, (i) processing source images to determine feature points in a scene, (ii) filtering and consistently correlating the feature points across different camera views, and (iii) comparing the correlated feature points. However, such methods are computationally expensive and can have scale ambiguities that decrease system accuracy. Moreover, existing methods based on feature point comparison may not be applicable to heterogeneous systems if cameras do not have overlapping spectral sensitivities.

FIG. 3 is a schematic diagram of a portion of the system 100 illustrating camera selection for comparing a rendered image to a raw image to assess calibration of the system 100 in accordance with embodiments of the present technology. More specifically, FIG. 3 illustrates three of the cameras 112 (identified individually as a first camera 112₁, a second camera 112₂, and a third camera 112₃) configured to capture images of the scene 108. In the illustrated embodiment, the second camera 112₂ is chosen for validation/verification (e.g., for calibration assessment), and images from the first and third cameras 112₁ and 112₃ are used to render a synthesized output image from the perspective of a virtual camera 112v having the same extrinsic and intrinsic parameters (e.g., pose, orientation, focal length) as the second camera 112₂. Although rendering and comparison of a single pixel is shown in FIG. 3, one of ordinary skill in the art will appreciate that the steps/features described below can be repeated (e.g., iterated) to render and then compare an entire image. Moreover, while three of the cameras 112 are shown in FIG. 3 for simplicity, the number of cameras 112 is not limited and, in practice, many more cameras can be used.

In the illustrated embodiment, to generate the synthesized/computed output image, for a given virtual pixel Pᵥ of the output image (e.g., where Pᵥ can refer to a location (e.g., an x-y location) of the pixel within the 2D output image), a corresponding world point W is calculated using the pose of the virtual camera 112v and the geometry of the scene 108, such as the measured depth of the scene 108. Therefore, the world point W represents a point in the scene 108 corresponding to the virtual pixel Pᵥ based on the predicted pose of the virtual camera 112v and the predicted geometry of the scene 108. More specifically, to determine the world point W, a ray Rᵥ is defined from an origin of the virtual camera 112v (e.g., an origin of the virtual camera 112v as modeled by a pinhole model) through the virtual pixel Pᵥ such that it intersects the world point Win the scene 108.

To determine a value for the virtual pixel Pᵥ, rays R₁ and R₃ are defined from the same world point W to the first and third cameras 112₁ and 112₃, respectively. The rays R₁ and R₃ identify corresponding candidate pixels P₁ and P₃ of the first and third cameras 112₁ and 112₃, respectively, having values that can be interpolated or otherwise computed to calculate a value of the virtual pixel Pᵥ. For example, in some embodiments the value of the virtual pixel Pᵥ can be calculated as an average of the candidate pixels P₁ and P₃:

$${P}_{V} = \frac{{P}_{1} + {P}_{3}}{2}$$

The computed value of the virtual pixel Pᵥ can be compared to a value of a corresponding pixel P₂ of the second camera 112₂ that is directly measured from image data of the scene 108 captured by the second camera 112₂. In some embodiments, the comparison generates an error value/metric representative of the calibration of the system 100 (e.g., of the second camera 112₂). For example, as the system 100 approaches perfect calibration, the comparison will generate an error value approaching zero as the computed value of the virtual pixel Pᵥ approaches the measured value of the actual pixel P₂.

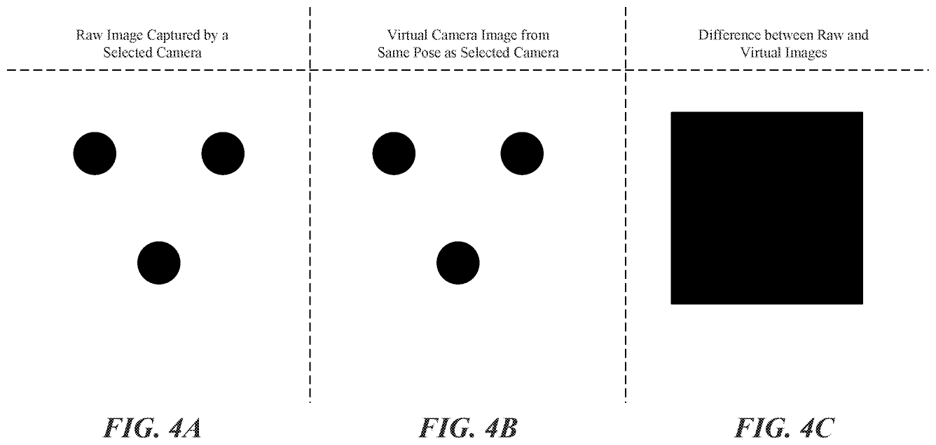

As one example, FIGS. 4A-4C are schematic illustrations of a raw image captured by a selected camera (e.g., the second camera 112₂), the virtual image rendered to correspond with the selected camera, and the difference between the raw image and the virtual image, respectively, in the case of accurate system calibration in accordance with embodiments of the present technology. As shown, the there is no difference between the raw and virtual images when the system 100 is accurately calibrated. The raw and virtual images can be compared using image similarity metrics such as Euclidian distance, optical flow, cross correlation, histogram comparison, and/or with other suitable methods.

Typically, however, the system 100 will include sources of error that can cause the raw image to diverge from the computed virtual image outside of an acceptable tolerance. For example, the raw image captured with the second camera 112₂ will typically include noise arising from the physical capture process. In some embodiments, the raw image can be filtered (e.g., compared to a simple threshold) to remove the noise. In other embodiments, the noise characteristics of the individual cameras 112 can be measured and applied to the rendered virtual image for a more accurate comparison.

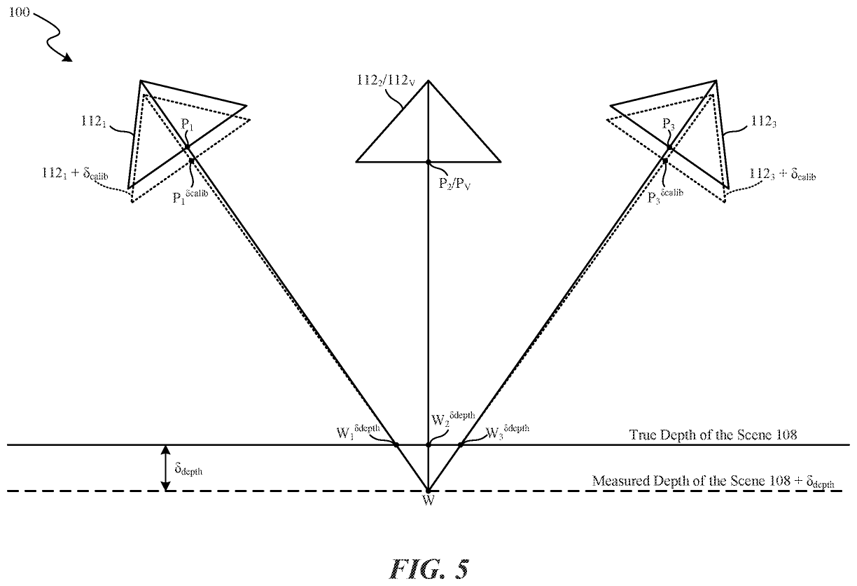

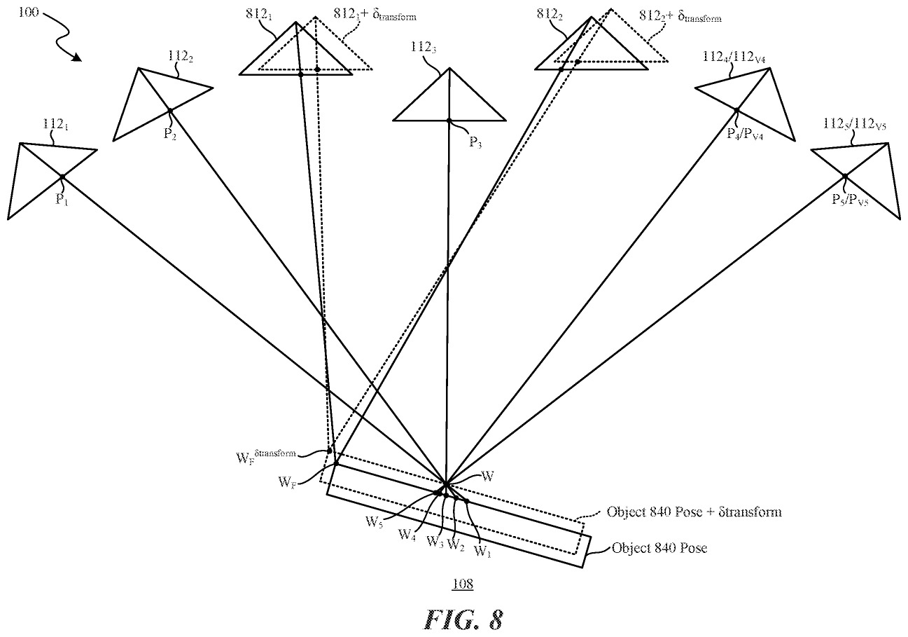

The original calibration of the cameras 112 and the depth measurement of the scene 108 can also introduce error into the system 100. For example, FIG. 5 is a schematic diagram of the portion of the system 100 shown in FIG. 3 illustrating the effects of calibration error δ_{calib} and depth error δ_{depth} in accordance with embodiments of the present technology. The calibration error δ_{calib} can arise from degradation of the system 100 over time due to environmental factors. For example, the system 100 can generate significant heat during operation that causes thermal cycling, which can cause relative movement between the lens elements and image sensors of individual ones of the cameras 112—thereby changing the intrinsic parameters of the cameras. Similarly, the assembly carrying the cameras 112 can warp due to thermal cycling and/or other forces, thereby changing the extrinsic parameters of the cameras 112. Where the depth of the scene 108 is calculated from image data from the cameras 112 alone, the depth error δ_{depth} can arise from both (i) the algorithms used to process the image data to determine depth and (ii) the underlying calibration error δ_{calib} of the cameras 112. Where the depth of the scene 108 is calculated from a dedicated depth sensor, the depth error δ_{depth} can arise from (i) the algorithms used to process the sensor data to determine depth and (ii) as well as the measured transform between the reference frame of the dedicated depth sensor and the cameras 112, as described in detail below with reference to FIG. 8.

In the illustrated embodiment, due to the depth error δ_{depth} in the measured depth of the scene 108, rather than the world point W, the world point measured by the first camera 112₁ is W₁^{δdepth} the world point measured by the second camera 112₂ is W₂^{δdepth} and the world point measured by the third camera 112₃ is ^{W}₃^{δdepth}. Moreover, due to calibration error δ_{calib} in the calibration of the cameras 112, the calculated poses of the cameras 112 measuring these world points differ from the actual poses such that the first camera 112₁ measures the world point ^{W}₁^{67 depth} at corresponding pixel P₁^{δcalib} rather than at the (correct) pixel P₁, and the third camera 112₃ measures the world point W₁^{67 depth} at corresponding pixel P₃^{δcalib} rather than at the (correct) pixel P_{3.} Accordingly, the value of the virtual pixel Pᵥ can be calculated as an average of the pixels P₁^{δcalib} and P₃^{δcalib}.

$${P}_{V} = \frac{{P}_{1}^{δ calib} + {P}_{3}^{δ calib}}{2}$$

The computed value of the virtual pixel Pᵥ can be compared to a value of a corresponding pixel P₂ of the second camera 112₂ that is directly measured from image data of the scene 108 captured by the second camera 112₂. In some embodiments, the comparison generates an error value/metric representative of the calibration of the system 100.

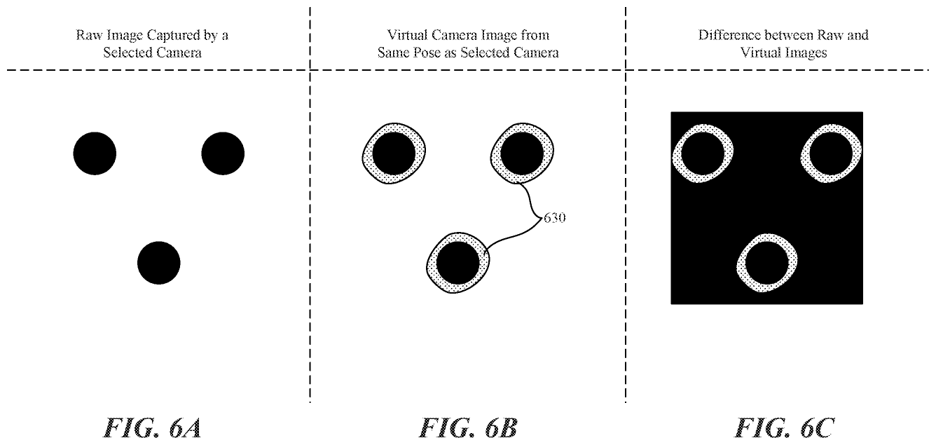

As one example, FIGS. 6A-6C are schematic illustrations of a raw image captured by a selected camera (e.g., the second camera 112₂), the virtual image rendered to correspond with the selected camera, and the difference between the raw image and the virtual image, respectively, in the case of the calibration error cahb and the depth error δ_{depth} in accordance with embodiments of the present technology. As shown, the calibration error δ_{calib} and the depth error δ_{depth} are manifested in the computed virtual camera image (FIG. 6B) as blurriness 630 over the entire virtual camera image. In some embodiments, the error can be classified by analyzing the frequency content and/or another property of the virtual camera image. For example, while the computed virtual camera image (FIG. 6B) and the raw image (FIG. 6A) appear similar, the computed virtual camera image can have attenuated high frequency content as measured by the Fourier transform of the image. Similarly, the computed virtual camera image can be considered to have (i) an increase in feature size compared to the raw image and (ii) a corresponding decrease in the edge sharpness of the features. Accordingly, in other embodiments the error can be classified by applying an edge filter (e.g., a Sobel operator) to the raw image and the computed virtual image. Specifically, the error can be represented/classified as increase in the number of edges and a decrease in the average edge magnitude in the images due to the misalignment of the views/poses of the cameras 112 in the computed virtual camera image. In yet other embodiments, a modulated transfer function (MTF) can be used to determine a sharpness of the raw and computed images.

While FIGS. 3 and 5 illustrate error calculation only for the selected second camera 112₂, the specific one of the cameras 112 selected for verification can be alternated/cycled throughout the entire camera array 110. After the system 100 (e.g., the validation processing device 105; FIG. 1) calculates error metrics for all or a subset of the cameras 112, the system 100 can calculate an average calibration error for the cameras 112. In some embodiments, this average error can be compared to the specific error calculated for individual ones of the cameras 112 to quantify the specific camera error against the average error of the cameras 112.

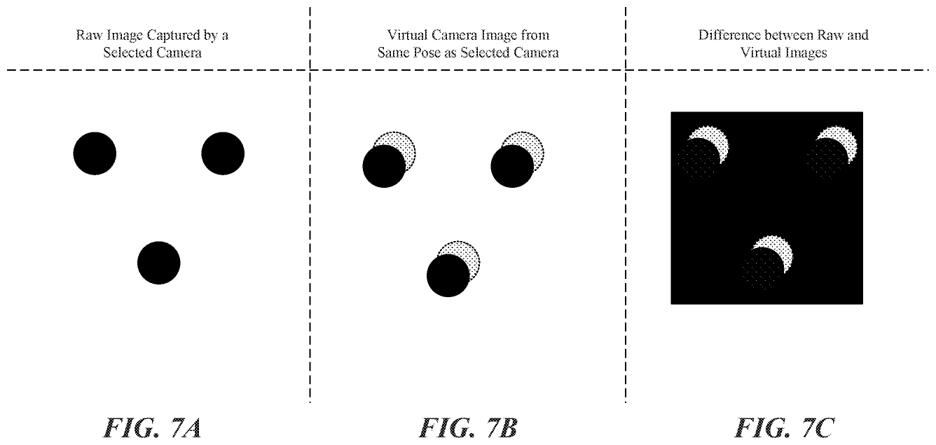

As one example, FIGS. 7A-7C are schematic illustrations of a raw image captured by a selected camera (e.g., the second camera 112₂), the virtual image rendered to correspond with the selected camera, and the difference between the raw image and the virtual image, respectively, in the case of the selected camera having a relatively large error compared to an average system error in accordance with embodiments of the present technology. As shown in FIG. 7C, when the selected camera has a high calibration error, the error can appear as a relative shift between the raw image (FIG. 7A) and the captured virtual camera image (FIG. 7B). In some embodiments, the shift between the raw and captured images can be quantified/classified using cross-correlation. For example, the raw image can be cross-correlated with itself and with the computed virtual camera image. Then, the relative location of the maximum intensity pixel in each cross-correlated set can be compared.

FIG. 8 is a schematic diagram of a portion of the system 100 including cameras of two different types and illustrating camera selection for comparing a rendered image to a raw image to assess calibration of the system 100 in accordance with embodiments of the present technology. More specifically, FIG. 8 illustrates five of the cameras 112 (identified individually as first through fifth cameras 112₁-112₅) configured to capture images (e.g., light filed image data) of the scene 108 for rendering the output image of the scene 108. In the illustrated embodiment, the system 100 further includes tracking cameras 812 (identified individually as a first tracking camera 812₁ and a second tracking camera 812₂) configured for use in tracking an object 840 through/in the scene 108. In some embodiments, the tracking cameras 812 are physically mounted within the camera array 110 with the cameras 112 while, in other embodiments, the tracking cameras 812 can be physically separate from the cameras 112. The object 840 can be, for example, a surgical tool or device used by a surgeon during an operation on a patient positioned at least partially in the scene 108, a portion of the surgeon's hand or arm, and/or another object of interest that is movable through the scene 108. Although rendering and comparison of a single pixel is shown in FIG. 8, one of ordinary skill in the art will appreciate that the steps/features described below can be repeated (e.g., iterated) to render and then compare an entire image. Moreover, while five of the cameras 112 and two of the tracking cameras 812 are shown in FIG. 8 for simplicity, the number of cameras 112 and tracking cameras 812 is not limited and, in practice, many more cameras can be used.

In some embodiments, the tracking cameras 812 can determine a depth and pose of the object 840 within scene, which can then be combined with/correlated to the image data from the cameras 112 to generate an output image including a rendering of the object 840. That is, the system 100 can render the object 840 into the output image of the scene 108 that is ultimately presented to a viewer. More specifically, the tracking cameras 812 can track one or more feature points on the object 840. When the system 100 includes different types of cameras as shown in FIG. 8, error can arise from the calibrated transform between the different sets of cameras. For example, where depth is calculated from the separate tracking cameras 812, error can arise from (i) the algorithms used to process the data from the tracking cameras 812 to determine depth and (ii) the calibrated transform between the cameras 112 and the separate tracking cameras 812. This error is referred to generally in FIG. 8 as transform error δ_{transform}. Moreover, each of cameras 112 and the tracking cameras 812 can include calibration errors, and the system 100 can include depth error, as described in detail above with reference to FIGS. 5-7C. Calibration and depth error are not considered in FIG. 8 for the sake of clarity.

In the illustrated embodiment, the fourth and fifth cameras 112₄ and 112₅ are chosen for verification (e.g., for calibration assessment), and image data from the first through third cameras 112₁-112₃ is used to render synthesized output images from the perspectives of a virtual camera 112v4 and a virtual camera 112v5 having the same extrinsic and intrinsic parameters (e.g., pose, orientation, focal length) as the fourth and fifth cameras 112₄ and 112_{5,} respectively. In some embodiments, the cameras 112 chosen for verification can be positioned near one another. For example, the fourth and fifth cameras 112₄ and 112₅ can be mounted physically close together on a portion of the camera array 110. In some embodiments, such a validation selection scheme based on physical locations of the cameras 112 can identify if a structure (e.g., frame) of the camera array 110 has warped or deflected.

Due to the transform error δ_{transform}, the tracking cameras 812 each measure/detect a feature point W_{F}^{δtransform} of the object 840 having a position in the scene 108 that is different than the position of an actual feature point W_{F} of the object 840 in the scene 108 and/or as measured by the cameras 112. That is, the transform error -transform shifts the locations of the measured feature points on the tracked object 840 relative to their real-world positions. This shift away from the real feature point W_{F} results in a shift in data returned by the system 100 when rendering the output image including the object 840. For example, in the illustrated embodiment a world point W on the surface of the object 840 is chosen for verification, as described in detail above with reference to FIGS. 3-7C. The world point W represents a point on the object 840 corresponding to (i) a virtual pixel Pᵥ₄ based on the predicted pose of the virtual camera 112v4 and the predicted pose of the object 840 (e.g., as determined by the tracking cameras 812) and (ii) a virtual pixel Pᵥ₅ based on the predicted pose of the virtual camera 112v5 and the predicted pose of the object 840.

In the illustrated embodiment, due to the transform error δ_{transform}, the actual world points measured by the first through fifth cameras 112₁-112₅—instead of the erroneous world point W—are world points W₁-W_{5,} respectively, which correspond to pixels P¹-P_{5,} respectively. Therefore, the transform error δ_{transform} causes a shift or a difference in a localized region of the output image corresponding to the object 840.

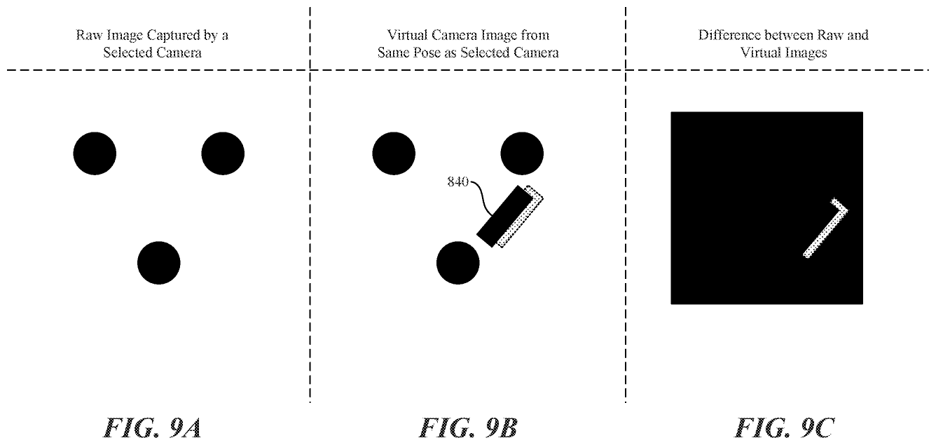

As one example, FIGS. 9A-9C are schematic illustrations of a raw images captured by one of the selected cameras (e.g., the fourth camera 112₄ or the fifth camera 112₅), the virtual image rendered to correspond with the selected camera, and the difference between the raw image and the virtual image, respectively, in the case of transform error in accordance with embodiments of the present technology. Referring to FIG. 8-9C together, the transform error δ_{transform} causes a shift in a localized region of the computed virtual camera image corresponding to the object 840. In some embodiments, the system 100 can generate an image mask that labels regions of the computed virtual camera image (FIG. 9B) based on the source of their 3D data. This mask can be used along with the image comparison to determine that the calibrated transform to a particular subset of different cameras (e.g., the tracking cameras 812 or another subset of a heterogenous camera system) has high error. Moreover, in some embodiments the computed virtual camera image can include localized error arising from material properties (e.g., reflectivity, specularity) of the scene 108 that impact the ability of the cameras 112 and/or the tracking cameras 812 to capture accurate images or depth in that region. In some embodiments, such localized error can be detected if the error region does not correlate with a heterogeneous data source in the image mask. In some embodiments, the source of this error can be further determined through analysis of the source images or depth map.

FIG. 8 considers the error arising from integrating data from heterogenous types of cameras into the system 100 and, specifically, from integrating tracking information from the tracking cameras 812 with the image data from the cameras 112. In other embodiments, other types of data can be integrated into system 100 from other modalities and the present technology can calculate error metrics for the system 100 based on the different heterogenous data sets.

Referring to FIG. 1, for example, in some embodiments the system 100 can receive volumetric data of the scene 108 captured by a modality such as computed tomography (CT), magnetic resonance imaging (MRI), and/or other types of pre-operative and/or intraoperative imaging modalities. Such volumetric data can be aligned with and overlaid over the rendered output image to present a synthetic augmented reality (e.g., mediated-reality) view including the output image of the scene 108 (e.g., a surgical site) combined with the volumetric data. Such a mediated-reality view can allow a user (e.g., a surgeon) to, for example, view (i) under the surface of the tissue to structures that are not yet directly visible by the camera array 110, (ii) tool trajectories, (iii) hardware placement locations, (iv) insertion depths, and/or (v) other useful data. In some embodiments, the system 100 (e.g., the processing device 102) can align the output image rendered from images captured by the cameras 112 with the volumetric data captured by the different modality by detecting positions of fiducial markers and/or feature points visible in both data sets. For example, where the volumetric data comprises CT data, rigid bodies of bone surface calculated from the CT data can be registered to the data captured by the cameras 112. In other embodiments, the system 100 can employ other registration processes based on other methods of shape correspondence, and/or registration processes that do not rely on fiducial markers (e.g., markerless registration processes). In some embodiments, the registration/alignment process can include features that are generally similar or identical to the registration/alignment processes disclosed in U.S. patent application Ser. No. 16/749,963, titled “ALIGNING PRE-OPERATIVE SCAN IMAGES TO REAL-TIME OPERATIVE IMAGES FOR A MEDIATED-REALITY VIEW OF A SURGICAL SITE,” and filed Jan. 22, 2020, now U.S. Pat. No. 10,912,625, which is incorporated herein by reference in its entirety.

With no loss of generality, such registration of volumetric data to a real-time rendered output image of a scene can be equated to the calibration of heterogenous camera types as described in detail with reference to FIG. 8. That is, the registration process is fundamentally computationally similar to aligning/registering the heterogenous data sets from the tracking cameras 812 and the cameras 112. Accordingly, the methods of determining calibration error metrics of the present technology can be used to assess the accuracy of a registration process that aligns volumetric data from a different modality with the rendered output image. For example, the system 100 can generate one or more error metrics indicative of how accurately registered CT data is with the output image rendered from the images captured by the cameras 112. In some embodiments, such error metrics can be repeatedly calculated during operation (e.g., during a surgical procedure) to ensure consistent and accurate registration. Therefore, the present invention is generally applicable to dynamic and static calibrations of camera systems as well as registration of data (e.g., 3D volumetric data) that such camera systems may integrate.

Referring to FIGS. 1-9C together, in some embodiments the computed calibration quality metrics of the present technology represent a measurement of the full error of the system 100. In some embodiments, the present technology provides a computationally tractable method for quantifying this error as well as estimating the sources of the error. Furthermore, analysis of the error can be used to determine the dominant error sources and/or to attribute error to specific subsystems of the system 100. This analysis can direct the user to improve or correct specific aspects of system calibration to reduce the full error of the system 100.

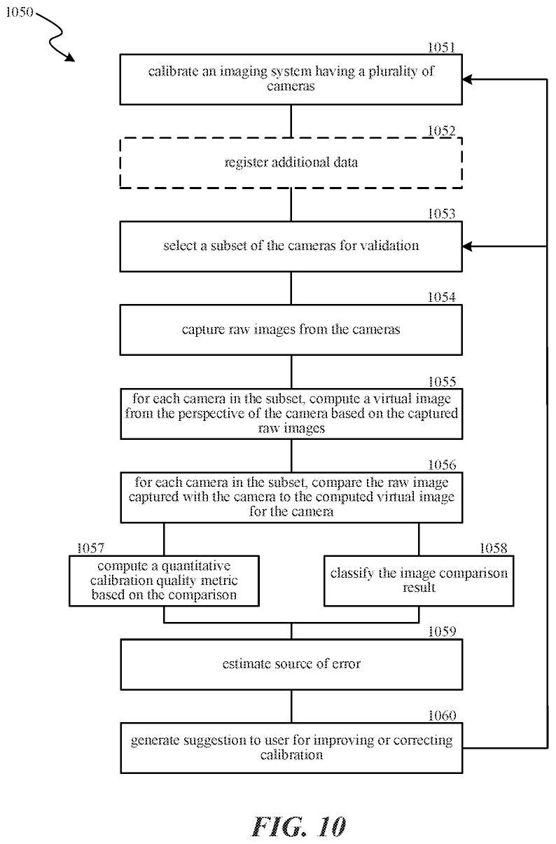

FIG. 10 is a flow diagram of a process or method 1050 for computing and/or classifying error metrics for the system 100 in accordance with embodiments of the present technology. Although some features of the method 1050 are described in the context of the embodiments shown in FIGS. 1-9C for the sake of illustration, one skilled in the art will readily understand that the method 1050 can be carried out using other suitable systems, devices, and/or processes described herein.

At block 1051, the method 1050 includes calibrating the system 100 including the cameras 112. For example, the calibration process can determine a pose (e.g., a position and orientation) for each of the cameras 112 in 3D space with respect to a shared origin. As described in detail with reference to FIG. 1, in some embodiments the calibration process can include correlating feature points across different camera views.

At block 1052, the method 1050 can optionally include registering or inputting additional data into the system 100, such as volumetric data collected from modalities other than the cameras 112 (e.g., CT data, Mill data). Such volumetric data can ultimately be aligned with/overlaid over the output image rendered from images captured by the cameras 112.

At block 1053, the method includes selecting a subset (e.g., one or more) of the cameras 112 for verification/validation. As shown in FIGS. 3 and 5, for example, the second camera 1122 can be selected for validation based on images captured by the first camera 112₁ and the third camera 112₃. Similarly, as shown in FIG. 8, the fourth and fifth cameras 112₄ and 112₅ can be chosen for validation based on images captured by the first through third cameras 112₁-112₃. In some embodiments, the cameras 112 chosen for verification can be positioned near one another (e.g., mounted physically close together on a portion of the camera array 110).

At block 1054, the method 1050 includes capturing raw images from the cameras 112—including from the subset of the cameras 112 selected for validation.

At block 1055, the method 1050 includes computing a virtual image from the perspective (e.g., as determined by the calibration process) of each of the cameras 112 in the subset selected for validation. As described in detail with reference to FIGS. 3, 5, and 8, the virtual images can be computed based on the raw images from the cameras 112 not selected for validation. Specifically, virtual pixels can be generated for the virtual image by weighting pixels from the cameras 112 that correspond to the same world point in the scene 108.

At block 1066, the method 1050 includes comparing the raw image captured by each of the cameras 112 in the subset for validation with the virtual image computed for the camera. The raw and virtual images can be compared using image similarity metrics such as Euclidian distance, optical flow, cross correlation, histogram comparison, and/or with other suitable methods.

At block 1057, the method 1050 can include computing a quantitative calibration quality metric based on the comparison. The calibration quality metric can be a specific error attributed to each of the cameras 112 in the subset selected for validation. In other embodiments, the computed calibration quality metric represents a measurement of the full error of the system 100.

Alternatively or additionally, at block 1058, the method 1050 can include classifying the result of the image comparison using cross-correlation and/or another suitable technique. At block 1059, the method 1050 can further include estimating a source of error in the system 100 based on the classification. That is, the system 100 can attribute the error to an underlying cause based at least in part on the image comparison. For example, as shown in FIGS. 7A-7C, a relative shift between a raw image and a computed virtual image for the same camera can indicate that the camera is out of alignment relative to a calibrated state.

At block 1060, the method 1050 can optionally include generating a suggestion to a user of the system 100 for improving or correcting system calibration. For example, if one of the cameras 112 is determined to be out of alignment relative to the calibrated state, the system 100 can generate a notification/indication to the user (e.g., via the display device 104) indicating that the particular camera should be realigned/recalibrated.

The method 1050 can then return to block 1051 and proceed again after a new recalibration of the system 100. Alternatively or additionally, the method 1050 can return to block 1053 and iteratively process different subsets of the cameras 112 until all the cameras 112 are validated.

### III. ADDITIONAL EXAMPLES

The following examples are illustrative of several embodiments of the present technology:

1. A method of validating a computational imaging system including a plurality of cameras, the method comprising:
selecting one of the cameras for validation, wherein the camera selected for validation has a perspective relative to a scene;
capturing first images of the scene with at least two of the cameras not selected for validation;
capturing a second image of the scene with the camera selected for validation;
generating, based on the first images, a virtual image of the scene corresponding to the perspective of the camera selected for validation; and
comparing the second image of the scene to the virtual image of the scene.

2. The method of example 1 wherein the method further comprises computing a quantitative calibration quality metric based on the comparison of the second image to the virtual image.

3. The method of example 1 or example 2 wherein the method further comprises classifying the comparison of the second image to the virtual image to estimate a source of error in the imaging system.

4. The method of example 3 wherein classifying the comparison includes applying an edge filter to the second image and the virtual image.

5. The method of any one of examples 1-4 wherein capturing the first images of the scene includes capturing light field images.

6. The method of any one of examples 1-5 wherein the cameras include at least two different types of cameras.

7. The method of any one of examples 1-6 wherein the method further comprises analyzing a frequency content of the virtual image and the second image to classify an error in the virtual image.

8. The method of any one of examples 1-7 wherein comparing the second image with the virtual image includes detecting a relative shift between the second image and the virtual image.

9. The method of any one of examples 1-8 wherein generating the virtual image includes, for each of a plurality of pixels of the virtual image—
determining a first candidate pixel in a first one of the first images, wherein the first candidate pixel corresponds to a same world point in the scene as the pixel of the virtual image;
determining a second candidate pixel in a second one of the first images, wherein the second candidate pixel corresponds to the same world point in the scene as the pixel of the virtual image; and
weighting a value of the first candidate pixel and a value of the second candidate pixel to determine a value of the pixel of the virtual image.

10. The method of any one of examples 1-9 wherein the method further comprises:
estimating a source of error in the imaging system based on the comparison of the second image to the virtual image; and
generating a user notification including a suggestion for correcting the source of error.

11. A system for imaging a scene, comprising:
a plurality of cameras arranged at different positions and orientations relative to the scene and configured to capture images of the scene; and
a computing device communicatively coupled to the cameras, wherein the computing device has a memory containing computer-executable instructions and a processor for executing the computer-executable instructions contained in the memory, and wherein the computer-executable instructions include instructions for—
selecting one of the cameras for validation;
capturing first images of the scene with at least two of the cameras not selected for validation;
capturing a second image of the scene with the camera selected for validation;
generating, based on the first images, a virtual image of the scene corresponding to the position and orientation of the camera selected for validation; and
comparing the second image of the scene to the virtual image of the scene.

12. The system of example 11 wherein the cameras are light field cameras.

13. The system of example 11 or example 12 wherein the computer-executable instructions further include instructions for computing a quantitative calibration quality metric based on the comparison of the second image to the virtual image.

14. The system of any one of examples 11-13 wherein the computer-executable instructions further include instructions for classifying the comparison of the second image to the virtual to estimate a source of error in the system.

15. The system of any one of examples 11-14 wherein the cameras are rigidly mounted to a common frame.

16. A method of verifying a calibration of a first camera in a computational imaging system, the method comprising:
capturing a first image with the first camera;
generating a virtual second image corresponding to the first image based on image data captured by multiple second cameras; and
comparing the first image to the virtual second image to verify the calibration of the first camera.

17. The method of example 16 wherein verifying the calibration includes determining a difference between the first image and the virtual second image.

18. The method of example 16 or example 17 wherein the first camera has a position and an orientation, and wherein generating the virtual second image includes generating the virtual second image for a virtual camera having the position and the orientation of the first camera.

19. The method of any one of examples 16-18 wherein the first camera and the second cameras are mounted to a common frame.

20. The method of any one of examples 16-19 wherein the method further comprises determining a source of a calibration error based on the comparison of the first image to the virtual second image.

### IV. CONCLUSION

The above detailed description of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments can perform steps in a different order. The various embodiments described herein can also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of validating a computational imaging system including a plurality of cameras, the method comprising:
selecting one of the cameras for validation, wherein the camera selected for validation has a perspective relative to a scene;
capturing first images of the scene with at least two of the cameras not selected for validation;
capturing a second image of the scene with the camera selected for validation;
generating, based on the first images, a virtual image of the scene corresponding to the perspective of the camera selected for validation; and
comparing the second image of the scene to the virtual image of the scene.

2. The method of claim 1 wherein the method further comprises computing a quantitative calibration quality metric based on the comparison of the second image to the virtual image.

3. The method of claim 1 wherein the method further comprises classifying the comparison of the second image to the virtual image to estimate a source of error in the imaging system.

4. The method of claim 3 wherein classifying the comparison includes applying an edge filter to the second image and the virtual image.

5. The method of claim 1 wherein capturing the first images of the scene includes capturing light field images.

6. The method of claim 1 wherein the cameras include at least two different types of cameras.

7. The method of claim 1 wherein the method further comprises analyzing a frequency content of the virtual image and the second image to classify an error in the virtual image.

8. The method of claim 1 wherein comparing the second image with the virtual image includes detecting a relative shift between the second image and the virtual image.

9. The method of claim 1 wherein generating the virtual image includes, for each of a plurality of pixels of the virtual image—
determining a first candidate pixel in a first one of the first images, wherein the first candidate pixel corresponds to a same world point in the scene as the pixel of the virtual image;
determining a second candidate pixel in a second one of the first images, wherein the second candidate pixel corresponds to the same world point in the scene as the pixel of the virtual image; and
weighting a value of the first candidate pixel and a value of the second candidate pixel to determine a value of the pixel of the virtual image.

10. The method of claim 1 wherein the method further comprises:
estimating a source of error in the imaging system based on the comparison of the second image to the virtual image; and
generating a user notification including a suggestion for correcting the source of error.

11. A system for imaging a scene, comprising:
a plurality of cameras arranged at different positions and orientations relative to the scene and configured to capture images of the scene; and
a computing device communicatively coupled to the cameras, wherein the computing device has a memory containing computer-executable instructions and a processor for executing the computer-executable instructions contained in the memory, and wherein the computer-executable instructions include instructions for—selecting one of the cameras for validation;
capturing first images of the scene with at least two of the cameras not selected for validation;
capturing a second image of the scene with the camera selected for validation;
generating, based on the first images, a virtual image of the scene corresponding to the position and orientation of the camera selected for validation; and
comparing the second image of the scene to the virtual image of the scene.

12. The system of claim 11 wherein the cameras are light field cameras.

13. The system of claim 11 wherein the computer-executable instructions further include instructions for computing a quantitative calibration quality metric based on the comparison of the second image to the virtual image.

14. The system of claim 11 wherein the computer-executable instructions further include instructions for classifying the comparison of the second image to the virtual to estimate a source of error in the system.

15. The system of claim 11 wherein the cameras are rigidly mounted to a common frame.

16. A method of verifying a calibration of a first camera in a computational imaging system, the method comprising:
capturing a first image with the first camera;
generating a virtual second image corresponding to the first image based on image data captured by multiple second cameras; and
comparing the first image to the virtual second image to verify the calibration of the first camera.

17. The method of claim 16 wherein verifying the calibration includes determining a difference between the first image and the virtual second image.

18. The method of claim 16 wherein the first camera has a position and an orientation, and wherein generating the virtual second image includes generating the virtual second image for a virtual camera having the position and the orientation of the first camera.

19. The method of claim 16 wherein the first camera and the second cameras are mounted to a common frame.

20. The method of claim 16 wherein the method further comprises determining a source of a calibration error based on the comparison of the first image to the virtual second image.
